(19) United States
(12) Patent Application Publication
(10) Pub. No.: US 2006/0080533 A1
(43) Pub. Date: Apr. 13, 2006

(54) System and method for providing e-mail verification

(76) Inventor: Alexander M. Bradbury, Aventura, FL (US)

Correspondence Address: Christopher J. Capelli, 2 Suzanne Lane, Chappaqua, NY, 10514, US

(21) Appl. No.: 10/962,263

(22) Filed: Oct. 9, 2004

(51) Int. Cl. H04L 9/00; G06F 15/16

(52) U.S. Cl. 713/170; 709/206

(57) ABSTRACT

The present invention relates to a method and system for certifying the transmission of an electronic document that is being transmitted from a sender's electronic device to a recipient's electronic device wherein the electronic document contains at least a header portion containing addressing information and a body portion. A first identifier is determined that is representative of at least a portion of the body portion of the electronic document to be sent and a separate second identifier is determined that is representative of at least a portion of the body portion of the aforesaid electronic document. These identifiers are then stored and after the document is transmitted to a recipient, a third identifier is determined that is representative of at least a portion of the header portion of the electronic document received on the recipient's' electronic device and a fourth identifier is determined that is representative of at least a portion of the body portion of the electronic document received on the recipient's' electronic device. If the third and fourth identifiers are respectively the same as the first and second identifiers stored in the database then certification for the electronic document is provided.

### I. TECHNICAL FIELD

This invention relates generally to the field of computer data security, and more particularly, to security for electronic mail messages.

### II. BACKGROUND OF THE INVENTION

The widespread use of electronic mail (e-mail) and groupware applications coupled with the growth and ubiquity of the Internet have opened new avenues for business level communications and electronic commerce. Organizations are increasingly relying on e-mail for the transfer of critical files such as purchase orders, sales forecasts, financial information and contracts both within the organization and increasingly with other organizations via the Internet. In this setting, these files are now tangible information assets that must be protected.

A number of conventional security measures exist to insure the confidentiality and integrity of modern data communications. For example, traditional firewalls prevent network access by unauthorized users. Secure sockets technology allows for data to be passed securely over the World Wide Web (WWW). E-mail, however, which is by far the most prominent application over the Internet, still remains problematic, from a security standpoint, for most organizations. Traditionally, firewalls are used to provide such security, but firewalls simply limit access to information protected by the firewall and do not contain the capability to limit transfer of information, into or out of an organization, by way of e-mail. This can lead to inadvertent or deliberate disclosure of confidential information from e-mail originating within an organization and introduction of viruses from e-mail entering an organization.

One solution to protecting confidentiality of e-mail messages is by encrypting such messages. Further security is available by way of digital signatures, which provide for authentication of e-mail messages. Encryption and authentication are both supported in the S/MIME (Secure/Multipurpose Internet Mail Extensions) messaging protocol defined in documents generated by the Internet Engineering Task Force (IETF) entitled “S/MIME Message Specification” (1997) and “S/MIME Certificate Handling“(1997). Individual users can encrypt/decrypt and authenticate e-mail messages using commercially available software. However, the use of software to perform such tasks is not always simple and therefore can detract from the inherent ease of use of e-mail as a means of communication. Moreover, an organization wishing to use such software must rely on individual users to encrypt all necessary messages without means of any centralized control. In addition, many conventional firewalls contain no capability to control the content or format of certain messages that enter or exit an organization.

There is accordingly a need for a system and method that provides for secure e-mail through verifying the authenticity of the e-mail's author and contents which system and method is readily adaptable to existing e-mail structure while overcoming the noted disadvantageous of the prior art attempts for doing so.

### III. SUMMARY OF THE INVENTION

Accordingly the present invention relates to a method and system for certifying the transmission of an electronic document that is being transmitted from a sender's electronic device to a recipient's electronic device, which method and system may be readily adapted to a user's existing e-mail system.

In a preferred embodiment, the present invention relates to a system and method that provides a remote electronic certification device, which is preferably located at a location remote from both the sender's and recipient's respective electronic devices (e.g., personal computers (PC)). Preferably, the remote electronic certification device is also itself a personal computer. In use, when a user desires to compile an e-mail that is to be sent, and subsequently certified, the user's PC establishes at least temporary communication between the user's PC and the remote electronic certification device. The user then proceeds to compile the e-mail message on the user's PC by preferably completing first the header portion, then the body portion of the e-mail message. Pursuant to the ensuing certification process, and prior to transmitting the e-mail message to a recipient, at least a portion of the header portion of the e-mail message is transmitted from the user's PC to the remote electronic certification device. Upon receipt, the remote electronic certification device computes a first identifier (e.g., a first checksum) representative of at least a portion of the header portion of the e-mail being compiled on the user's PC. Preferably next, at least a portion of the body portion of the e-mail message being compiled on the user's PC is transmitted to the remote electronic certification device, and again, preferably prior to the e-mail message being transmitted to a recipient. Again upon receipt, the remote electronic certification device then computes a second identifier (e.g., a second checksum) representative of at least a portion of the body portion of the e-mail message being compiled on the user's PC. The remote electronic certification device then stores these first and second identifiers preferably in a designated electronic file in an associated database of the electronic certification device.

When a user has completed compiling the e-mail message, this e-mail message is then transmitted from the user's PC to a recipient's PC, via conventional e-mail techniques. The recipient then receives this transmitted e-mail at the recipient's PC using the recipient's existing, and preferably non-modified e-mail client (e.g., MICROSOFT OUTLOOK). When the recipient desires to obtain certification for the received e-mail message, at least temporary communication is established between the recipient's PC and the remote electronic device, preferably via a hyper-link provided in the e-mail message. Pursuant to the e-mail certification process, at least a portion of the header portion of the e-mail message received on the recipient's PC is transmitted from the recipient's PC to the remote electronic certification device. Additionally, at least a portion of the body portion of the e-mail message received on the recipient's PC is transmitted to the remote electronic certification device.

Upon receipt of the aforesaid transmitted information from the recipient's PC, the remote electronic certification device computes a third identifier (e.g., a third checksum) representative of at least a portion of the header portion of the e-mail message received on the recipient's' PC. Also, the remote electronic certification device computes a fourth identifier (e.g., a fourth checksum) representative of at least a portion of the body portion of the e-mail message received on the recipient's' PC. The remote electronic certification device then preferably determines if the aforesaid third and fourth identifiers are respectively the same as the first and second identifiers stored in said remote electronic certification device, which were associated with the aforesaid e-mail transmitted from the user's PC to the recipients PC. If it is determined the first and third identifiers are the same, respectively, as the second and fourth identifiers, then the remote electronic certification device provides certification for the aforesaid e-mail message transmitted from the aforesaid user's PC to the aforesaid recipient's PC. This certification notice may be provided to both the recipient and user.

In essence, this certification provides assurance that the received e-mail was indeed sent from the party it represents to be sent from and the contents of the e-mail message were also not altered, or in any way tampered with, during the transmission from the user's PC to the recipient's PC.

### IV. BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the processor-based systems of a preferred embodiment of the present invention;

FIG. 2 illustrates a flow chart diagram of a user registering to use of the present invention of FIG. 1;

FIG. 3 illustrates a flow chart diagram illustrating the process of acquiring and generating data necessary for verifying the authenticity of an e-mail in accordance with the present invention of FIG. 1; and

FIG. 4 illustrates a flow chart diagram illustrating the process of verifying the authenticity of an e-mail received in accordance with the present invention of FIG. 1.

### V. DETAILED DESCRIPTION OF THE PREFERRED EMBODIMENT

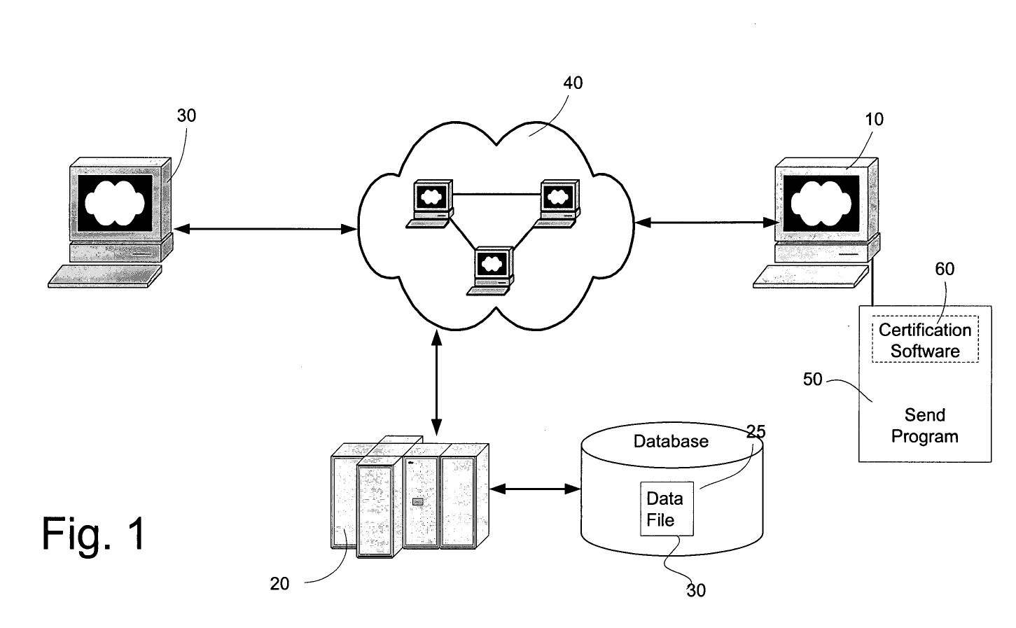

The present invention provides for the general certification of electronic delivery of a transmitted document (e.g., an e-mail message). Although the present invention may be accomplished through varying means, the preferred embodiment of the present invention is described below with reference to FIGS. 1-4.

It is to be appreciated that the system of the present invention operates in conjunction with known e-mail architecture. For instance, it is to be understood that in accordance with the present invention system, e-mail is processed via a Simple Mail Transfer Protocol (SMTP) relay module which performs the functions of a conventional Internet relay host. An example of an Internet relay host is a send mail program, whereupon the SMTP relay module transmits and receives e-mail messages from both internal and external sites. As is conventional, an e-mail message, as described hereunder takes the form of a conventional e-mail message which contains a plurality of user specified information fields, such as source field specifying an e-mail address for the source of the message, a destination field specifying one or more destination e-mail address(es) for the message, a subject field specifying a subject for the message, a body field specifying the body of the message containing textual and/or graphics data, and an attachment field specifying one or more files to be transmitted with the message. Other user specified fields include, but are not limited to, priority of the message, identity of the sending agent and the date and time of the message.

It is to be further appreciated that e-mail messages may be encoded in accordance with one of a plurality of known encoding formats and that the SMTP relay module preferably takes a conventional form of a software module which receives and transmits e-mail messages in accordance with the Simple Mail Transfer Protocol as specified by Internet RFC 821. The SMTP protocol is not critical and may be replaced with a module that receives and/or transmits messages in other formats such as the File Transfer Protocol (FTP) or the Hyper-Text Transfer Protocol (HTTP). The SMTP relay module can preferably be configured to use Domain Name System (DNS) to determine routing to message recipients or alternatively can relay messages to an administrator specified SMTP host. If DNS is selected, a default SMTP host can still be specified to allow a message to be forwarded even if DNS service is not available. Also, it is to be appreciated that the term “INTERNET” is well known in the art as designating a specific global international computer network that operates according to the TCP-IP protocol.

In accordance with the present invention system, a user invokes a first processor-based system (PC) to certifiably transmit a selected document (e.g., an e-mail message) via a program, hereinafter referred to as the “send program”, stored on the first PC. The send program requests input from the user, co-existing process, or coupled devices, about the electronic document to be transmitted, to whom it is to be transmitted, including an electronic address such as e-mail address, level of certification desired, etc. Preferably, the send program consists of a commercially available e-mail client such as OUTLOOK, commercially available from MICROSOFT or LOTUS NOTES, commercially available from IBM. A request for verification and certification is then made to a remote certification device. In the preferred embodiment the remote certification device is itself preferably another PC. Upon verification by the remote certification device, a checksum(s) and/or total bit count(s) is generated by the remote certification device for the e-mail message and additional information provided by the send program such as the recipient's electronic address identification of the sending site, time of document transmission, and number of pages in the document to be transmitted may also be utilized. It shall be understood that any form of summarily indicating the content of the electronic message may be utilized in place of a checksum and/or total bit count if desired. Furthermore, although the following discussion refers primarily to the use of a checksum, it shall be understood that any summary indication of the content of the electronic message in combination with, or in place of, a checksum may advantageously be used.

As will be further described below, a e-mail and its certification link is transmitted by the send program on the registered user's PC to a recipient's PC. In the preferred embodiment, the recipient site is also a PC. Upon receipt of the e-mail, the recipient then communicates with the remote certification PC, preferably via the certification link, to verify the received e-mail against the stored certification information regarding the received e-mail.

Referring to FIG. 1, there are illustrated processor-based systems (PCs) 10, 20 and 30 utilized in the above described preferred embodiment of the present invention. Specifically, PC 10 is utilized to implement the aforementioned send program 50, PC 20 is utilized to implement the certification process required for the e-mail, and PC 30 is utilized to receive an e-mail from the sender's PC 10 and e-mail certification from the remote certification PC 20. It is to be appreciated that PC's 10, 20 and 30 preferably each include a chassis enclosing a processor (CPU) and a media reader/recorder (e.g., disk drive). As such, PCs 10, 20 and 30 are preferably general purpose computers, such as an IBM compatible (or Apple Macintosh) controlled by any general purpose operating system such as DOS or UNIX. It should be noted that PCs 10, 20 and 30 may each be of differing types and/or controlled by different operating systems.

Still referring to FIG. 1, it can be seen that PCs 10, 20 and 30 are preferably linked together through the Internet 40. Connection to one another through the Internet 40 may be accomplished by any means now existing or later developed. Alternatively, PCs 10, 20 and 30 may be linked directly through digital telecommunications trunks (not shown) or through a digital network system (not shown). It shall be understood that in utilizing a digital network system to link PCs 10, 20 and 30, network interface cards (NIC) or other digital communications devices may be utilized, e.g. ISDN. It will be appreciated by those of skill in the art that any network linking PCs 10, 20 and 30 may either be secure or not, depending on the degree of security desired with respect to the transmission of the document to be certified.

With particular reference to PC 10, it is to be understood that its aforesaid send program 50 for compiling and transmitting an e-mail message includes certification software 60, preferably via a plug-in interfacing program in the send program 50, which performs the certification process of the present invention, as will now be described below.

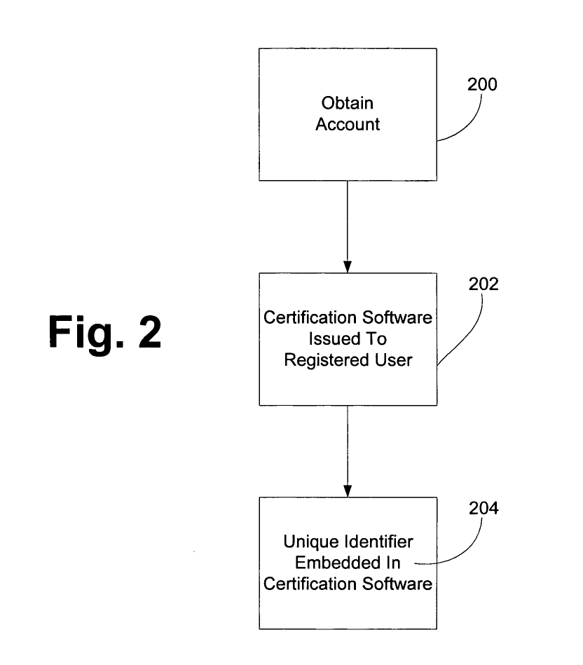

Directing attention to FIGS. 2-4, flow charts depicting the overall operation the system shown and illustrated in FIG. 1 are depicted.

First, and with specific reference to the flow chart of FIG. 2, a user preferably establishes an account with the certification service provider of remote certification PC 20 (step 200). Once an account is obtained (preferably thorough proper proof of the user's identification and any affiliations), the service provider of PC 20 issues the user's PC 10 certification software 60 that is to be embedded in the user's e-mail send program 50 (step 202). The e-mail certification software 60 issued to the registered user of PC 10 is preferably unique to that user in that it contains a unique user identifier that is associated preferably with the registered user's e-mail addresses(s) and/or IP addresses (step 204). The unique user identifier may be encrypted within the e-mail certification software 60. For example, a registered user may register the e-mail address marek@buyitnow.com with the certification service system of PC 20, which generates and assigns a unique identifier 112233 to be associated with the user's registered email address of marek@buyitnow.com as well as the registered user's IP address used for this e-mail address (marek@buyitnow.com). This identifier (e.g., 112233) is then preferably embedded in the e-mail certification software 60 issued to the registered user 10.

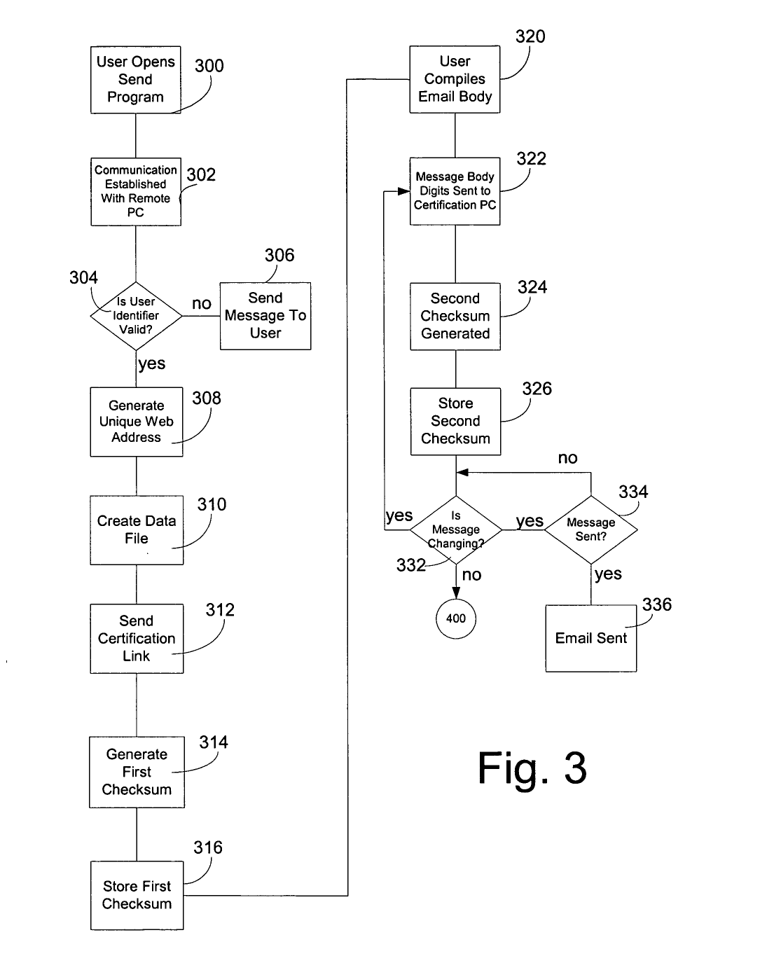

With reference now to FIG. 3 and starting with a registered user desiring to compile and transmit a certified e-mail message, the user activates the send program 50 on PC 10, which preferably also automatically activates the embedded certification software 60 (step 300). It shall be appreciated by one of skill in the art that the send program 50 and certification software 60 may be executed in the form of a terminate and stay resident (TSR) program and therefore allow for the automatic association by send program 50 of a document created within a co-executing process. In a preferred embodiment, the send program 50 is capable of execution in a multi-tasking environment, such as the MICROSOFT WINDOWS operating environment, therefore providing the ability to select and transmit an electronic document created in a co-executing process as well as to integrate a received certification indicia within the original electronic document.

At step 302 the send program 50, and particularly certification software 60, establishes communication between the user's PCs 10 and the remote certification PC 20, preferably via Internet 40. Preferably, during this communication the certification software 60 causes the unique identifier embedded within it (e.g., 112233) to be sent from the user's PC 10 to the remote certification PC 20.

The communication established in step 302 is suitable for data communications between PCs 10 and 20. In the preferred embodiment, communication step 302 includes the sub-steps of establishing data communications between the sender's PC's 10 and the remote certification PC 20, and as to providing information as to which resource available through the data communications access is to be utilized, and verifying that data communications with a document transmission certification system has been accomplished. It shall be understood that there is no limitation of the present invention to establish and terminate the communications link between the sender's PCs 10 and the remote certification PC 20. For example, where digital telecommunications trunks (not shown) or a digital network system (not shown) are utilized for linking PCs 10 and 20, a data communication link may advantageously be maintained for extended periods of time thereby eliminating the need for the send program 10 to establish and terminate the communications link.

Upon receipt of the users unique identifier (e.g., 112233), the remote certification PC 20 determines whether the transmitted unique identifier (e.g., 112233) is a valid registered user of the certification system of PC 20 and does it match properly with the associated user's e-mail address (e.g., marek@buyitnow.com) (step 304). If the user's transmitted unique identifier is not valid or does not properly match with the user's registered e-mail address, a message is sent to the user's PC 10 that this message cannot be certified by the remote certification system PC 20 (step 306). This message can occur through a dialog box or any other known means of providing a message from remote certification system 20 to the sender's PC 10.

If the user's unique identifier (e.g., 112233) is both valid and matches with the user's registered e-mail address (e.g., marek@buyitnow.com), the remote certification system PC 20 preferably generates a unique web address (e.g., www.microsentry.com/unique1) that is to be associated with the certification for this e-mail as described further below (step 308). Preferably, this unique address has a data file 30 associated with it in a database 25 associated with the remote certification PC 20, as also further described below (step 310).

The remote certification PC 20 then generates a certification web link, which is a web link to the aforesaid unique web address (e.g., marek@buyitnow.com). This web link also preferably contains software instruction causing an executing PC to forward the contents of the attached e-mail to the remote certification PC 20, again as will also be further explained below. This web link is then sent from the remote certification PC 20 to the user's PC 10 so as to be attached to preferably the footer portion of the e-mail being compiled on the user's PC 10 (step 312). In the preferred embodiment, if the send program 50 on the user's PC 10 is compiling a plain text email, the certification software 60 includes the web link as plain text. And if the send program 50 is compiling an HTML e-mail, the certification program 60 includes the web link as a graphic (e.g., a logo) in the e-mail. In either event, the aforesaid web link or graphic provides a web link directly to the remote certification system PC 20 when clicked upon by a recipient 30 of the e-mail, as will be explained further below.

When the user of PC 10 completes the addressing portions of the e-mail message in the e-mail send program 50 (e.g., To: gmchin@bidchat.com and From: marek@buyitnow.com) the certification software 60 preferably sends this information to the remote certification PC 20 to generate a first checksum representative of the digits contained in the header of the e-mail step 314. The remote certification system PC 20 also preferably stores this first checksum in the file 30 created in step 310 for this e-mail having the aforesaid prescribe unique web address (e.g., www.microsentry.com/unique1) (step 316)

The user then preferably proceeds to compile the body of the e-mail message whereupon as the user compiles each digit of the message body (step 320), each such digit is sent to the remote certification system PC 20, via certification software 60 and internet 40 (step 322). Upon receipt of each aforesaid message body digit, the remote certification system PC 20 generates a second checksum representative of the message body of the e-mail being compiled on the user's PC 10 (step 324). This second checksum is then automatically stored in the electronic file 30, along with the first checksum, associated with the aforesaid unique address (www.microsentry.com/unique1) created in step 314 (step 326).

As the user of PC 10 continues to change the digits in the message body of the e-mail (step 332), this change in digits is preferably instantly sent back to the remote certification system PC 20, via certification software 60 and Internet 40 whereupon steps 320 to 326 are repeated (step 332). Thus, as the user of PC 10 continues to alter the digits in the body of the e-mail, the second check sum stored in the file 30 of database 25 (in step 326) correspondingly changes.

A determination is then made in step 334 as to whether the e-mail message was sent from the user's PC 10, via send program 50 and Internet 40, to the intended e-mail recipient at PC 30 (e.g., gmchin@bidchat.com). If no, then the aforementioned determination is repeated at step 332 as to whether any of the digits of the e-mail being compiled on the user's PC 10 have changed. If yes (the e-mail was transmitted from the user's PC 10), then the certification program 60 preferably indicates to remote certification system PC 20 that the e-mail has been completed and transmitted to the intended recipient and this is preferably indicated in the file 30 in database 25 along with the time the e-mail was sent, which file was created at step 310 for this e-mail (step 336). Hence, what is preferably stored in the file 30 in database 25 is: the first checksum (indicative of the header information of the e-mail); the second checksum (indicative of the message body for the e-mail) and preferably the time the e-mail was transmitted from the user's PC 10.

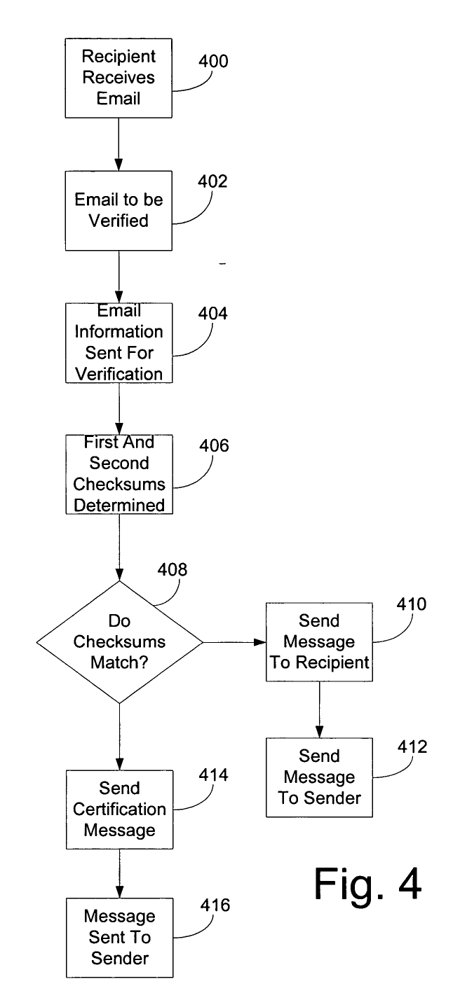

With reference now to FIG. 4, the process of receiving and verifying a certified e-mail will now be discussed. Starting at step 400, the recipient (e.g., gmchin@bidchat.com) at PC 30 receives the aforesaid e-mail transmitted from the sender's PC 10 with an e-mail client used by the recipient (e.g., Lotus Notes or Microsoft Outlook). It is noted that the recipient 30 does not need any software associated with the remote certification PC 20 (e.g., certification software 50) to receive and verify the e-mail. The e-mail is preferably viewed as an ordinary e-mail having the aforesaid certification link. To verify the authenticity of the e-mail, the recipient preferably clicks (e.g., selects) the aforesaid certification web link included in the e-mail as discussed above in step 312 with reference to FIG. 3(step 402). This selection of the certification link preferably causes the default browser of the recipients PC 30 to activate so to forward the contents of the e-mail (e.g., including the e-mail header and body information) to be sent to the designated web address (e.g., www.microsentry.com/unique1) in the remote certification PC 20 (step 404). Upon receipt of this information, the remote certification PC 20, calculates a first checksum for the received header information and a second checksum for the received body information (step 406). The remote certification PC 20 then compares these calculated first and second checksums to what was stored in the file 30 of the database 25 associated with the aforesaid designated web address (e.g., www.microsentry.com/unique1) (step 408). If they do not match, a message is preferably sent from the remote certification PC 20 to the recipients PC 30 that this message cannot be verified (step 410). A message may also be sent to the registered sender of the e-mail (e.g., sender's PC 10) that an e-mail message was received by a recipient at PC 30 but could not be verified (step 412). It is noted that the message sent to the recipient's PC 30 and/or sender's PC 10 can either be generic (e.g., indicating only that the message could not be verified) or detailed as to the reason why it could not be verified (e.g., an unauthorized change occurred in the header portion of the e-mail).

If a match of the first and second checksums is found in step 408, then a message is sent to the recipient's PC 30 indicating that the e-mail can be verified as being sent from the registered sender (e.g., marek@buyitnow.com) and that neither the header or body portion of the e-mail was altered during transmission from the sender's PC 10 (step 414). Additionally, a message may also be sent to the registered sender of the e-mail (e.g., sender's PC 10) that the e-mail message was received at a specified time and date and was able to be properly verified (step 416). Thus, this is analogous to a return receipt of the e-mail sent.

Although the present invention and its advantages have been described in detail, it should be understood that various changes, substitutions and alterations can be made herein without departing from the spirit and scope of the invention as defined by the appended claims.

What is claimed is:

1. A method for certifying the transmission of an electronic document that is being transmitted from a sender's electronic device to a recipient's electronic device wherein the electronic document contains at least a header portion containing addressing information and a body portion, said method comprising the steps of:
providing the electronic document on the sender's electronic device; determining a first identifier that is representative of at least a portion of the header portion of the electronic document provided on the sender's electronic device;
determining a second identifier that is representative of at least a portion of the body portion of the electronic document provided on the sender's electronic device;
storing the first and second identifiers in a database;
transmitting the electronic document from the sender's electronic device to the recipient's electronic device;
receiving the electronic document at the recipient's electronic device;
determining a third identifier that is representative of at least a portion of the header portion of the electronic document received on the recipient's' electronic device;
determining a fourth identifier that is representative of at least a portion of the body portion of the electronic document received on the recipient's' electronic device;
determining if the third and fourth identifiers are respectively the same as the first and second identifiers stored in the database; and
providing certification for the electronic document transmitted to the recipient's electronic device if the third and fourth identifiers are respectively the same as the first and second identifiers stored in the database.

2. A method as recited in claim 1 wherein the electronic document consists of an e-mail message.

3. A method as recited in claim 1 wherein the electronic device for each of the sender and recipient consist of a Personal Computer.

4. A method as recited in claim 1, wherein:
the first identifier is a checksum representative of said at least a portion of the header portion of the electronic document provided on the sender's electronic device;
the second identifier is a checksum representative of said at least a portion of the body portion of the electronic document provided on the sender's electronic device;
the third identifier is a checksum representative of said at least a portion of the header portion of the electronic document received on the recipient's' electronic device; and
the fourth identifier is a checksum representative of said at least a portion of the body portion of the electronic document received on the recipient's' electronic device.

5. A method as recited in claim 1 further including the step of providing a remote electronic device remote from both the sender's and transmitter's respective electronic devices.

6. A method as recited in claim 5, further including the steps of:
establishing at least temporary communication between the sender's electronic device and the remote electronic device;
transmitting said at least a portion of the header portion of the electronic document on the sender's electronic device to the remote electronic device;
transmitting said at least a portion of the body portion of the electronic document on the sender's electronic device to the remote electronic device;
determining in said remote electronic device said first and second identifiers respectively based upon said header and body portion of said electronic document; and
storing in said remote device said first and second identifiers.

7. A method as recited in claim 6, further including the steps of:
establishing at least temporary communication between the recipient's electronic device and the remote electronic device;
transmitting said at least a portion of the header portion of the electronic document on the recipient's electronic device to the remote electronic device;
transmitting said at least a portion of the body portion of the electronic document on the recipient's electronic device to the remote electronic device;
determining in said remote electronic device said third and fourth identifiers; and
determining in said remote electronic device if the third and fourth identifiers are respectively the same as the first and second identifiers stored in the database.

8. A method as recited in claim 7, further including the step of providing a copy of the electronic document transmitted from said sender's electronic device in said remote electronic device.

9. A method for certifying the transmission of an electronic document that is being transmitted from a sender's electronic device to a recipient's electronic device wherein the electronic document contains at least a header portion containing addressing information and a body portion, said method comprising the steps of:
providing a remote electronic certification device remote from both said sender's and recipient's respective electronic devices;
establishing at least temporary communication between the sender's electronic device and the remote electronic certification device;
compiling the electronic document by a user on the sender's electronic device;
transmitting at least a portion of the header portion of the electronic document on the sender's electronic device to the remote electronic certification device;
determining in said remote electronic certification device a first identifier representative of at least a portion of the header portion of the electronic document being compiled on the sender's electronic device;
transmitting said at least a portion of the body portion of the electronic document on the sender's electronic device to the remote electronic certification device;
determining in said remote electronic certification device a second identifier representative of at least a portion of the body portion of the electronic document being compiled on the sender's electronic device;
storing in said remote electronic certification device said first and second identifiers;
providing a link to said sender's electronic device associating said electronic document with said first and second identifiers stored in said remote electronic certification device;
embedding said link in said electronic document in said user's electronic device;
transmitting the electronic document from the sender's electronic device to the recipient's electronic device;
receiving the electronic document at the recipient's electronic device; establishing at least temporary communication between the recipient's electronic device and the remote electronic device via said link embedded in said electronic document;
transmitting at least a portion of the header portion of the electronic document received on the recipient's electronic device to the remote electronic certification device; transmitting at least a portion of the body portion of the electronic document received on the recipient's electronic device to the remote electronic certification device;
determining a third identifier in said remote electronic certification device that is representative of at least a portion of the header portion of the electronic document received on the recipient's' electronic device and transmitted to said remote electronic certification device;
determining a fourth identifier in said remote electronic certification device that is representative of at least a portion of the body portion of the electronic document received on the recipient's' electronic device and transmitted to said remote electronic certification device;
determining in said remote electronic certification device if said third and fourth identifiers are respectively the same as the first and second identifiers stored in said remote electronic certification device; and
providing certification from said remote electronic certification device for the electronic document transmitted to the recipient's electronic device if the third and fourth identifiers are respectively the same as the first and second identifiers.

10. A method as recited in claim 9 wherein the electronic document consists of an e-mail message.

11. A method as recited in claim 9 wherein the electronic device for each of the sender and recipient consist of a Personal Computer.

12. A method as recited in claim 9, wherein:
the first identifier is a checksum representative of said at least a portion of the header portion of the electronic document provided on the sender's electronic device;
the second identifier is a checksum representative of said at least a portion of the body portion of the electronic document provided on the sender's electronic device;
the third identifier is a checksum representative of said at least a portion of the header portion of the electronic document received on the recipient's' electronic device; and
the fourth identifier is a checksum representative of said at least a portion of the body portion of the electronic document received on the recipient's' electronic device.

13. A method as recited in claim 9, further including the step of providing a copy of the electronic document transmitted from said sender's electronic device in said remote electronic certification device.

14. A method as recited in claim 9, wherein the step of transmitting said at least a portion of the body portion of the electronic document on the sender's electronic device to the remote electronic certification device includes the step of:
transmitting all current digits contained in said body portion of said electronic document to said remote electronic certification device after each digit change in said body portion, whereafter said electronic certification device then determines a said second identifier based upon digits currently contained in said body portion of said electronic document.

15. A system for certifying the transmission of an electronic document to be transmitted from a sender's electronic device to a recipient's electronic device wherein the electronic document contains at least a header portion containing addressing information and a body portion, said system comprising:
means for determining a first identifier that is representative of at least a portion of the body portion of the electronic document provided on the sender's electronic device;
means for determining a second identifier that is representative of at least a portion of the body portion of the electronic document provided on the sender's electronic device;
means for storing the first and second identifiers in a database; means for transmitting the electronic document from the sender's electronic device to the recipient's electronic device;
means for receiving the electronic document at the recipient's electronic device;
means for determining a third identifier that is representative of at least a portion of the header portion of the electronic document received on the recipient's electronic device;
means for determining a fourth identifier that is representative of at least a portion of the body portion of the electronic document received on the recipient's electronic device;
means for determining if the third and fourth identifiers are respectively the same as the first and second identifiers stored in the database; and
means for providing certification for the electronic document transmitted to the recipient's electronic device if the third and fourth identifiers are respectively the same as the first and second identifiers stored in the database.

16. A system as recited in claim 15, wherein:
the first identifier is a checksum representative of said at least a portion of the header portion of the electronic document provided on the sender's electronic device;
the second identifier is a checksum representative of said at least a portion of the body portion of the electronic document provided on the sender's electronic device;
the third identifier is a checksum representative of said at least a portion of the header portion of the electronic document received on the recipient's' electronic device; and
the fourth identifier is a checksum representative of said at least a portion of the body portion of the electronic document received on the recipient's' electronic device.

17. A system as recited in claim 15, further including:
providing remote electronic certification device remote for both said sender's electronic device and said recipient's electronic device
means for establishing at least temporary communication between the sender's electronic device and the remote electronic certification device;
means for transmitting said at least a portion of the header portion of the electronic document on the sender's electronic device to the remote electronic certification device;
means for transmitting said at least a portion of the body portion of the electronic document on the sender's electronic device to the remote electronic certification device;
means for determining in said remote electronic certification device said first and second identifiers; and
means for storing in said first and second identifiers in said remote electronic certification device.

18. A system as recited in claim 17, further including:
means for establishing at least temporary communication between the recipient's electronic device and the remote electronic certification device;
means for transmitting said at least a portion of the header portion of the electronic document on the recipient's electronic device to the remote electronic certification device;
means for transmitting said at least a portion of the body portion of the electronic document on the recipient's electronic device to the remote electronic device;
means for determining in said remote electronic certification device said third and fourth identifiers; and
means for determining in said remote electronic certification device if the third and fourth identifiers are respectively the same as the first and second identifiers stored in said remote electronic certification device.

19. A method as recited in claim 15, further including means for providing a copy of the electronic document transmitted from said sender's electronic device in said remote electronic certification device.

20. A system as recited in claim 15, further including means for determining said second identifier for each digit change in said body portion of said electronic document without user intervention.
